(19) United States
(12) Patent Application Publication
(10) Pub. No.: US 2005/0038668 A1
(43) Pub. Date: Feb. 17, 2005

(54) System and method for document processing and charging for such processing on a per page basis

(75) Inventors: Harpreet Singh, Orange, CA (US); Marianne Kodimer, Huntington Beach, CA (US); Mustafa Seifi, Irvine, CA (US); Kenneth Stephenson, San Clemente, CA (US); Louis Ormond, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignees: Toshiba Corporation; Toshiba Tec Kabushiki Kaisha

(21) Appl. No.: 10/949,429

(22) Filed: Sep. 24, 2004

Related U.S. Application Data
(63) Continuation-in-part of application No. 10/746,530, filed on Dec. 24, 2003.
(60) Provisional application No. 60/437,644, filed on Jan. 2, 2003.

(51) Int. Cl. G06F 17/60

(52) U.S. Cl. 705/1

(57) ABSTRACT

This invention is directed to a mobile document processing system and method. More particularly, this invention is directed to a mobile document processing system and method wherein a user requests a selected document processing operation for a document and the fee for the operation is calculated on a per page basis.

### CROSS-REFERENCE TO RELATED APPLICATIONS

The present application is a continuation-in-part of U.S. application Ser. No. 10/746,530 filed Dec. 24, 2003, which claims the benefit of U.S. Provisional Application 60/437,644, filed Jan. 2, 2003.

### BACKGROUND OF THE INVENTION

This invention is directed to a mobile document processing system and method. More particularly, this invention is directed to a mobile document processing system and method wherein a user requests a selected document processing operation for a document and the fee for the operation is calculated on a per page basis.

Professionals routinely work with documents or other data while away from their office environment. These professionals need to generate hard copy or image data, such as by printing a document. They then to need to distribute or perform other functions on such image data. Multifunctional peripheral devices, which include functions such as printing, facsimile, and scanning, routinely perform such operations. The fees for such document processing operations are typically calculated based on the size of the electronic file associated with the document. If the document to be processed contains several images the size of the document will be much larger than a document containing only text, even though the page count for the image data printout is substantially less. Therefore, the cost of generating the document containing images will be more than the document containing only text. This is true, even though the use of consumables, such as paper and toner, may be less than needed for the text-based printouts. The user may not be aware of such differences in fees depending on the size of the file. If the fee is calculated on a per page basis, taking into account the number of images in the document, the user then knows exactly how much it will cost per page and can decide accordingly as to whether to proceed based on the cost.

There is a need for a system and method for mobile document processing which charges for such processing on a per page basis. Such a pricing scheme is suited to more accurately estimate a true cost of document production, and serves to provide a financial incentive due to savings and cost predictability that will allow consumers greater utilization of document processing services.

### SUMMARY OF THE INVENTION

In accordance with the present invention, there is provided a system and method for mobile document processing wherein such processing is calculated on a per page basis.

Further, in accordance with the present invention, there is provided a system and method for mobile document processing wherein a user requests a selected document processing operation for a document and the fee for the operation is quoted on a per page basis.

Further, in accordance with the present invention, there is provided a mobile document processing system comprising means adapted for receiving document data from an associated mobile data device and means adapted for receiving, from the associated mobile data device, processing instructions representative of a desired document processing operation to be performed on the document data. The system further comprises parsing means adapted for parsing the document data into a specified number of at least one processing unit in accordance with the document data and the processing instructions and fee calculation means adapted for calculating fee data associated with completion of the desired document processing operation relative to the at least one processing unit. The system also comprises means adapted for communicating the fee data to the associated mobile data device, means adapted for receiving, from the associated mobile data device, order data representative of a document processing order associated with the fee data and the document data, and means adapted for selectively commencing a document processing operation in accordance with received order data.

In a preferred embodiment, the parsing means includes means adapted for parsing the document data into a specified number of at least one processing unit corresponding to discrete pages associated with the document data after processing by the document processing operation. In a preferred embodiment, the system further comprises means adapted for receiving, from the associated mobile data device, payment data representative of a desired mechanism for securing payment for the document processing operation. The payment data includes data representative of at least one of a credit account, prepaid account, and partner account.

In a preferred embodiment, the system comprises means adapted for communicating the document data to an associated document rendering service in accordance with received order data. The system also preferably comprises means adapted for communicating payment data to the document rendering service, which payment data is representative of payment to the document rendering service for processing the document data.

Further, in accordance with the present invention, there is provided a mobile document processing method comprising the steps of receiving document data from an associated mobile data device and receiving, from the associated mobile data device, processing instructions representative of a desired document processing operation to be performed on the document data. The method also comprises the steps of parsing the document data into a specified number of at least one processing unit in accordance with the document data and the processing instructions, calculating fee data associated with completion of the desired document processing operation relative to the at least one processing unit and communicating the fee data to the associated mobile data device. The method further comprises the steps of receiving, from the associated mobile data device, order data representative of a document processing order associated with the fee data and the document data and selectively commencing a document processing operation in accordance with received order data.

In a preferred embodiment, the step of parsing document data includes parsing the document data into a specified number of at least one processing unit corresponding to discrete pages associated with the document data after processing by the document processing operation. In a preferred embodiment, the method further comprises the step of receiving, from the associated mobile data device, payment data representative of a desired mechanism for securing payment for the document processing operation. The payment data includes data representative of at least one of a credit account, prepaid account, and partner account.

In a preferred embodiment, the method comprises the step of communicating the document data to an associated document rendering service in accordance with received order data. The method also comprises the step of communicating payment data to the document rendering service, which payment data is representative of payment to the document rendering service for processing the document data.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating a system for providing fee-based data services to users in a non-office environment according to the present invention.

FIG. 2 is flowchart of one embodiment for providing fee-based data services to users in a non-office environment according to the present invention.

### DETAILED DESCRIPTION OF THE PREFERRED EMBODIMENTS

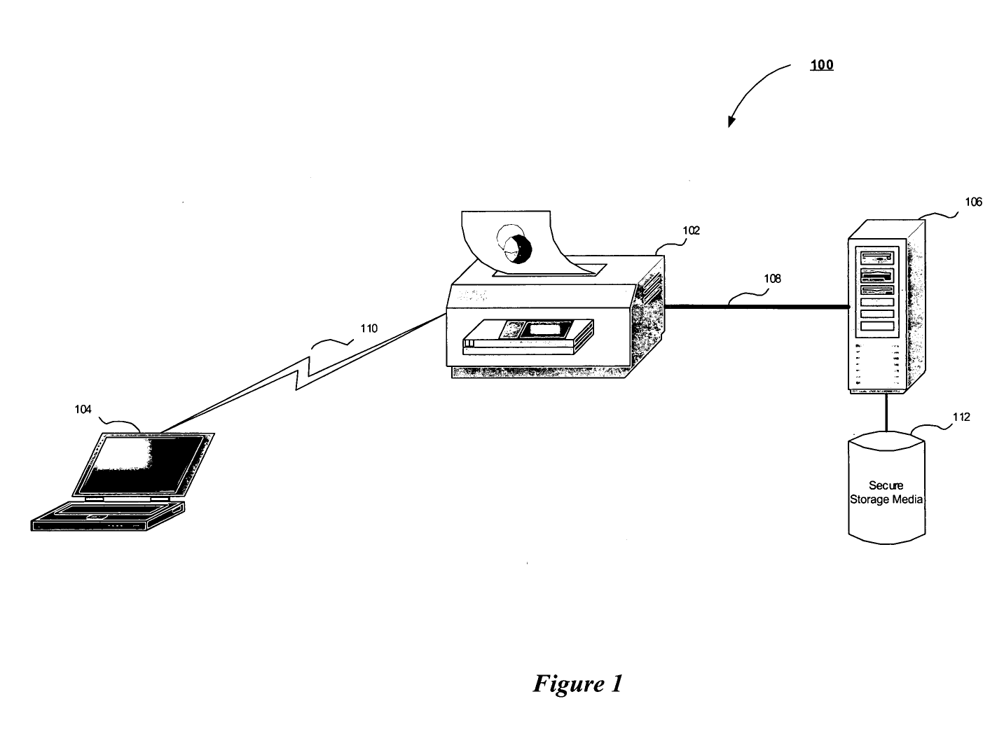

The present invention is directed to a mobile document processing system and method wherein the processing operations are charged on a per page basis. A diagram illustrating the system 100 is shown in FIG. 1. In the present invention, a mobile user is provided access to a multifunctional peripheral device 102 in a non-office or mobile environment, such as an airport lounge or business center. Other non-office environment locations include, but limited to, university campuses, conference centers, libraries, and hotels. The user accesses the multifunctional peripheral device 102 directly or via a computer or other suitable interface 104 via a suitable communication link 110. The multifunctional peripheral is connected to an associated central server 106 via a suitable communication link 108, such as the Internet. The central server includes an associated secure storage medium 112 for storing image data generated by the user. The user is then provided with information about the services available to be performed. The information is provided in any suitable manner known in the art. The information is suitably provided by way of a user interface associated with the multifunctional peripheral device or documentation provided related thereto.

The services provided to the user are those typically provided by multifunctional peripheral devices and associated software. In this invention, the system allows the user to generate image data, such as by printing or scanning a document, storing image data, or distribute image data.

The user is then provided with information about the available payment options for paying for the desired services. The payment options include any suitable payment options known in the art for charging for mobile fee-based services. Suitable payment options include, but are not limited to, credit cards, prepaid accounts, coupons, and partner accounts. These payment options can be suitably group accounts and individual accounts. The user then selects the desired payment option from the options provided.

The requirements for paying the fees depend on the payment option selected. If the user selects the credit card option, the user is prompted to provide selected information about the user's credit card, such as credit card type, credit card number, the credit card holder's name, and the expiration date. The information is suitably provided by the user by any suitable means known in the art. Examples of such input are by direct user input via a keyboard interface or the like, or by access to a pre-stored information on a memory device, such as a magnetic strip, embedded data storage or an intelligent card. The information is then sent to the central server via the communication link for authentication and approval from the credit card company shown as 108. Such information is provided by the central server to the credit card company by any suitable method known in the art. Given that sensitive information is being transmitted, a suitable security encryption or authentication system, as will be readily appreciated by one of ordinary skill in the art, is advantageously used. The authentication of the information and the transaction approval is provided by any suitable method known in the art. Preferably, the user is informed of the status of the approval. Preferably, if the transaction is not approved, the user is requested to submit information for an alternative credit card. In one embodiment, the user's credit card is charged for every transaction at the time of the transaction. In another embodiment, the user's credit card is charged for the transactions monthly or other suitable periodic interval.

If the user selects the prepaid account option, the user is prompted to open a prepaid account by a suitable method known in the art. Preferably, the user is prompted to open the prepaid account via a web-enabled user interface at specified URL that is served by the central server. The user provides selected information about a credit card or other type of debit card to open the account. Upon authentication of the information and approval of the use of the credit card by any suitable means, the user is issued an account identification and associated password for the account. Information about the account is maintained in any suitable database or repository, preferably, on the central server. In one embodiment, the balance maintained in the user account is debited every time the user accesses services on the system. In another embodiment, the balance is debited every month or other suitable periodic interval. The user may replenish the account by any suitable means at any time.

If the user selects the coupon option, the user is prompted to provide selected information about the coupons, such as the coupon issuer and the coupon number. This information is sent to the central server by any suitable means known in the art. The authentication of the information and the transaction approval is provided by any suitable method known in the art. Preferably, the user is informed of the status of the approval. Preferably, if the transaction is not approved, the user is requested to correct the information or provide alternative information. Preferably, the user is provided information about any applicable limits or restrictions on services associated with the use of the coupons, such as the number of pages printed.

If the user selects the partner account option, the user is prompted to selected a third party account provider from a list of available options by any suitable means. Examples of partner accounts, include, but are not limited to, Sprint PCS, AOL, Liberty Alliance, MS Passport, and AT&T. The user is prompted to provide selected information about the account, such as the account or user identification, and password. The information is provided to the central server by any suitable means known in the art. Such information is provided by the central server to the partner company by any suitable method known in the art. The authentication of the information and the transaction approval is provided by any suitable method known in the art. Preferably, the user is informed of the status of the approval. Preferably, if the transaction is not approved, the user is requested to correct the information or provide alternative information. In one embodiment, the user's account is charged for every transaction at the time of the transaction. In another embodiment, the user's account is charged for the transactions monthly or other suitable periodic interval. After selecting the desired payment option, the user is prompted to provide selected information about the desired service to be performed.

The user is then prompted to select the desired parameters for generating or receiving the image data. For example, if the user is printing a document, the user suitably provides information about the type of print job, color, dpi, and related information. After receiving such information, the system starts generating or receiving the image data.

Preferably, after performing the document processing operation, the system provides the user with the total cost associated with the selected services. It is understood however, that the total cost associated with the selected services may be provided to the user prior to generating and storing the image data. Once the user has accepted the services by any suitable means known in the art, the services are performed. Preferably, the system provides a report of the status of the services to the user. Preferably, the user can view the results and make any needed changes to the services if the results are not acceptable. Information relating to the services is stored an associated repository, preferably located on the central server. The user is then billed for the services performed depending on the payment option selected by any suitable means known in the art. Preferably, a receipt is provided to the user upon completion of the services desired.

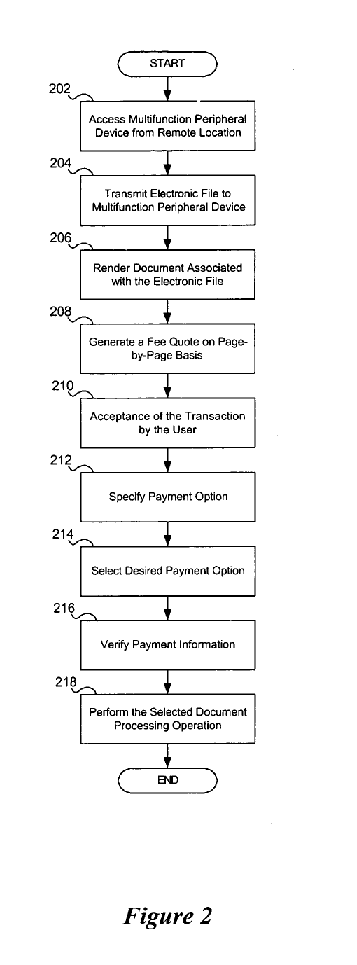

FIG. 2 shows a flowchart for offering mobile document processing services to users on a per page basis according to the present invention. In this embodiment, image data from is received from a storage medium via the multifunctional peripheral device and then the image data is stored or archived in an associated repository. As shown at 202, a user is provided access to a multifunctional peripheral device 102 in a non-office environment, such as an airport lounge or business center. The user accesses the multifunctional peripheral device via any suitable means, such as via a user interface associated with the multifunctional peripheral device. The user is presented with a description of the service to store or archive storage medium based files on an associated repository and the available payment options. The user selects the desired service via any suitable means.

At 204, the user transmits the electronic file associated with the document to the multifunctional peripheral device via any suitable means. In one embodiment, the user scans a hard copy of the document using the multifunctional peripheral device. The generated image data or electronic file is then stored in the multifunction peripheral device via any suitable means for future processing. In another embodiment, the user transmits or uploads or emails the electronic file associated with the document to the multifunctional peripheral device via any suitable means. In one embodiment, the user transmits the electronic file via a inserting storage media device containing the electronic file into a suitable receiving means in the multifunctional peripheral device and the electronic file is accessed or transferred to the multifunctional peripheral device via any suitable means. In another embodiment, the user transmits the electronic file via electronic mail server accessed via any suitable means, such as a user interface on a user terminal, a mobile device, or the like.

At 206, the multifunctional peripheral device renders the document via any suitable means and calculates the total number of pages to be generated. At 208, the system generates a fee quote for the processing operation on a per page basis via any suitable means. The fee quote is presented to the user via any suitable means, such as via a user interface associated with the multifunctional peripheral device or with an associated user terminal in data communication with the multifunctional peripheral device.

At 210, the user accepts the transaction via any suitable means. At 212, the user is prompted to specify a payment option via any suitable means and to provide the necessary information for the associated payment option.

At 214, the user selects the desired payment option via any suitable means and provides the information required to effectuate such payment via any suitable means. At 216, the system verifies the payment information received from the user. Upon verification of the payment information as shown at 218, the system performs the selected document processing operation.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention.

1. A mobile document processing system comprising:
means adapted for receiving document data from an associated mobile data device;
means adapted for receiving, from the associated mobile data device, processing instructions representative of a desired document processing operation to be performed on the document data;
parsing means adapted for parsing the document data into a specified number of at least one processing unit in accordance with the document data and the processing instructions;
fee calculation means adapted for calculating fee data associated with completion of the desired document processing operation relative to the at least one processing unit;
means adapted for communicating the fee data to the associated mobile data device;
means adapted for receiving, from the associated mobile data device, order data representative of a document processing order associated with the fee data and the document data; and
means adapted for selectively commencing a document processing operation in accordance with received order data.

2. The mobile document processing system of claim 1 wherein the parsing means includes means adapted for parsing the document data into a specified number of at least one processing unit corresponding to discrete pages associated with the document data after processing by the document processing operation.

3. The mobile document processing system of claim 1 further comprising means adapted for receiving, from the associated mobile data device, payment data representative of a desired mechanism for securing payment for the document processing operation.

4. The mobile document processing system of claim 3 wherein the payment 5 data includes data representative of at least one of a credit account, prepaid account, and partner account.

5. The mobile document processing system of claim 1 wherein the document processing operation includes at least one of facsimile, printing, scanning, and storage.

6. The mobile document processing system of claim 5 further comprising means adapted for selecting parameters for a selected document processing operation undertaken.

7. The mobile document processing system of claim 1 further comprising means adapted for communicating the document data to an associated document rendering service in accordance with received order data.

8. The mobile document processing system of claim 7 further comprising means adapted for communicating payment data to the document rendering service, which payment data is representative of payment to the document rendering service for processing the document data.

9. A mobile document processing method comprising the steps of:
receiving document data from an associated mobile data device;
receiving, from the associated mobile data device, processing instructions representative of a desired document processing operation to be performed on the document data;
parsing the document data into a specified number of at least one processing unit in accordance with the document data and the processing instructions;
calculating fee data associated with completion of the desired document processing operation relative to the at least one processing unit;
communicating the fee data to the associated mobile data device;
receiving, from the associated mobile data device, order data representative of a document processing order associated with the fee data and the document data; and
selectively commencing a document processing operation in accordance with received order data.

10. The mobile document processing method of claim 9 wherein the step of parsing the document data includes parsing the document data into a specified number of at least one processing unit corresponding to discrete pages associated with the document data after processing by the document processing operation.

11. The mobile document processing method of claim 9 further comprising the step of receiving, from the associated mobile data device, payment data representative of a desired mechanism for securing payment for the document processing operation.

12. The mobile document processing method of claim 11 wherein the payment data includes data representative of at least one of a credit account, prepaid account, and partner account.

13. The mobile document processing method of claim 9 wherein the document processing operation includes at least one of facsimile, printing, scanning, and storage.

14. The mobile document processing method of claim 13 further comprising means adapted for selecting parameters for a selected document processing operation undertaken.

15. The mobile document processing method of claim 9 further comprising the step of communicating the document data to an associated document rendering service in accordance with received order data.

16. The mobile document processing method of claim 16 further comprising the step of communicating payment data to the document rendering service, which payment data is representative of payment to the document rendering service for processing the document data.

17. A computer-readable medium of instruction for mobile document processing comprising:
instructions for receiving document data from an associated mobile data device;
instructions for receiving, from the associated mobile data device, processing instructions representative of a desired document processing operation to be performed on the document data;
instructions for parsing the document data into a specified number of at least one processing unit in accordance with the document data and the processing instructions;
instructions for calculating fee data associated with completion of the desired document processing operation relative to the at least one processing unit;
instructions for communicating the fee data to the associated mobile data device;
instructions for receiving, from the associated mobile data device, order data representative of a document processing order associated with the fee data and the document data; and
instructions for selectively commencing a document processing operation in accordance with received order data.

18. The computer-readable medium of instruction of claim 17 wherein the instructions for parsing document data includes instructions for parsing the document data into a specified number of at least one processing unit corresponding to discrete pages associated with the document data after processing by the document processing operation.

19. The computer-readable medium of instruction of claim 17 further comprising instructions for receiving, from the associated mobile data device, payment data representative of a desired mechanism for securing payment for the document processing operation.

20. The computer-readable medium of instruction of claim 19 wherein the payment data includes data representative of at least one of a credit account, prepaid account, and partner account.

21. The computer-readable medium of instruction of claim 17 wherein the document processing operation includes at least one of facsimile, printing, scanning, and storage.

22. The computer-readable medium of instruction of claim 17 further comprising means adapted for communicating the document data to an associated document rendering service in accordance with received order data.

23. The computer-readable medium of instruction of claim 22 further comprising instructions for communicating payment data to the document rendering service, which payment data is representative of payment to the document rendering service for processing the document data.

24. A computer-implemented method of mobile document processing comprising the steps of:
receiving document data from an associated mobile data device;
receiving, from the associated mobile data device, processing instructions representative of a desired document processing operation to be performed on the document data;
parsing the document data into a specified number of at least one processing unit in accordance with the document data and the processing instructions;
calculating fee data associated with completion of the desired document processing operation relative to the at least one processing unit;
communicating the fee data to the associated mobile data device;
receiving, from the associated mobile data device, order data representative of a document processing order associated with the fee data and the document data; and
selectively commencing a document processing operation in accordance with received order data.

25. The computer-implemented method of claim 24 wherein the step of parsing the document data includes parsing the document data into a specified number of at least one processing unit corresponding to discrete pages associated with the document data after processing by the document processing operation.

26. The computer-implemented method of claim 24 further comprising the step of receiving, from the associated mobile data device, payment data representative of a desired mechanism for securing payment for the document processing operation.

27. The computer-implemented method of claim 26 wherein the payment data includes data representative of at least one of a credit account, prepaid account, and partner account.

28. The computer-implemented method of claim 24 wherein the document processing operation includes at least one of facsimile, printing, scanning, and storage.

29. The computer-implemented method of claim 24 further comprising the step of communicating the document data to an associated document rendering service in accordance with received order data.

30. The computer-implemented method of claim 29 further comprising the step of communicating payment data to the document rendering service, which payment data is representative of payment to the document rendering service for processing the document data.
